(19) United States
(12) Patent Application Publication
(10) Pub. No.: US 2010/0205777 A1
(43) Pub. Date: Aug. 19, 2010

(54) ROUTING FLEXIBLE PRINTED CIRCUIT BOARD THROUGH HINGE OF ELECTRONIC DEVICE

(76) Inventor: David K.J. KIM, Mission Viejo, CA (US)

Correspondence Address: KYOCERA INTERNATIONAL INC.;INTELLECTUAL PROPERY DEPARTMENT, P.O. BOX 928289, SAN DIEGO, CA, 92192, US

(21) Appl. No.: 12/371,549

(22) Filed: Feb. 13, 2009

(51) Int. Cl. E05D 5/10

(52) U.S. Cl. 16/386

(57) ABSTRACT

A hinge is configured for routing electrical wiring therein. The hinge includes a pair of opposing bosses aligned along a rotational axis and a hollow portion having ends respectively engaging the bosses. The hollow portion is rotatable about the rotational axis, relative to the bosses. Wiring, such as a flexible printed circuit board (FPCB) has a portion thereof inserted into the hollow portion. A rod is inserted into the hollow portion and aligned along the rotational axis. The rod fixes the inserted portion of the wiring in a neutral position, and thus, reduces wear and tear on the wiring caused by the hinge action.

### TECHNICAL FIELD

The present invention generally relates to electronic devices, and more particularly, to electronic devices that include wiring that passes between hinged elements.

### BACKGROUND

Many contemporary electronic devices include hinged components so that the devices can be folded in order to reduce their overall physical sizes. Cellular “flip” phones and laptop computers are common examples of such electronic devices.

In many cases, these hinged electronic devices include electronics that are located within the housings on both sides of a hinge. Usually, these electronics are wired together with wires that are routed through and concealed within the hinge. For example, many contemporary flip phones have an electronic display screen located on the top half of the phone and a keypad located on the bottom half of the phone. The top and bottom halves are connected together with a hinge that permits the phone to be opened and closed. In order to display numbers and letters that are entered using the keypad of the bottom half on the upper-half display screen, the keypad and the display screen are essentially connected together by wiring that is concealed within the hinge.

Routing the wiring through a hinge presents certain technical difficulties and reliability issues.

### SUMMARY

Repeatedly cycling of a hinged electronic device through opened and closed positions can cause wear and tear to wiring routed within the hinge, thus, eventually causing the electronic device to stop operating properly. Wear and tear on the wiring is frequently caused by the wiring rubbing against the interior walls of the hinge. In addition, the hinge action during opening and closing may also cause torsion, stretching and/or skewing of the wiring within the hinge, which may lead to unreliable operation or failure of the electronic device. Manufacturing variances may also make it difficult to consistently place conventional wiring within the hinge so as to avoid the wear and tear effects normally associated with hinge action.

To overcome these problems, an improved hinge assembly is disclosed. The assembly includes a hinge configured to route and conceal electrical wiring. The hinge includes a pair of opposing bosses aligned along a rotational axis and a hollow portion having ends respectively engaging the bosses. The hollow portion is rotatable about the rotational axis, relative to the bosses. Wiring, such as a flexible printed circuit board (FPCB), has a portion thereof inserted into the hollow portion. A rod is inserted into the hollow portion and aligned along the rotational axis. The rod fixes the inserted portion of the wiring in a neutral position, avoiding contact with the interior walls of the hinge, and thus, reduces wear and tear on the wiring caused by the hinge action. The rod also keeps the wiring from stretch and/or skewing inside the hinge. The addition of the rod into the interior of the hinge significantly improves the reliability of the electrical connection passing through the hinge.

Other aspects, features, advantages of the hinge assembly will be or will become apparent to one with skill in the art upon examination of the following figures and detailed description. It is intended that all such additional aspects, features, and advantages be included within this description and be protected by the accompanying claims.

### BRIEF DESCRIPTION OF THE DRAWINGS

It is to be understood that the drawings are solely for purpose of illustration and do not define the limits of what is claimed. Furthermore, the components in the figures are not necessarily to scale. In the figures, like reference numerals designate corresponding parts throughout the different views.

FIG. 1 is a perspective view of an exemplary cellular flip phone 10 that includes a flexible printed circuit board routed through a hinge.

FIG. 2 is a plan view of the flexible printed circuit board included in the phone shown in FIG. 1.

FIG. 3 is a cross-sectional view of the hinge assembly of the cellular phone show in FIG. 1.

FIG. 4 is a perspective view of the rotatable hollow portion of the hinge assembly with the flexible printed circuit board inserted.

FIG. 5A is a cross-sectional view of the insert portion of the flexible printed circuit board prior to attachment to the rod.

FIG. 5B is a cross-sectional view of the rotatable hollow portion along section A-A of FIG. 4, with the flexible printed circuit board attached to the rod.

### DETAILED DESCRIPTION

The following detailed description, which references to and incorporates the drawings, describes and illustrates one or more specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

The word “exemplary” is used throughout this disclosure to mean “serving as an example, instance, or illustration.” Any embodiment or feature described herein as “exemplary” is not necessarily to be construed as preferred or advantageous over other embodiments or features.

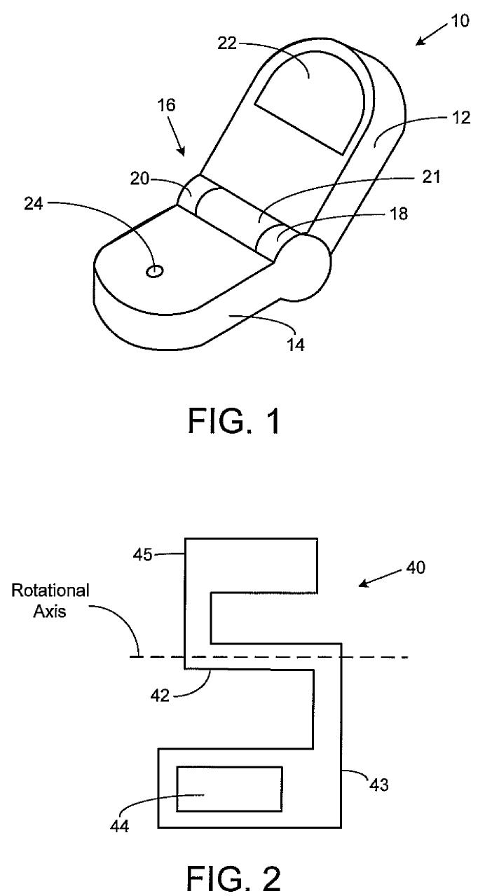

FIG. 1 is a perspective view of an exemplary cellular flip phone 10 that includes a flexible printed circuit board (FPCB) routed through a hinge 16. The phone 10 includes an upper half 12 connected to a lower half 14 by the hinge 16. The halves 12, 14 each represent a hinged element. Each half 12, 14 includes electronics that are wired together with one or more wires that are routed through and concealed within the hinge 16. For example, phone 10 includes an electronic display screen 22, such as a liquid crystal display (LCD), located on the upper half 12 of the phone 101 and a microphone 24 and keypad (not shown) located on the lower half 14 of the phone 10. The keypad, display screen 22 and other electronic components not shown are essentially connected together by wiring that is concealed within the hinge 16.

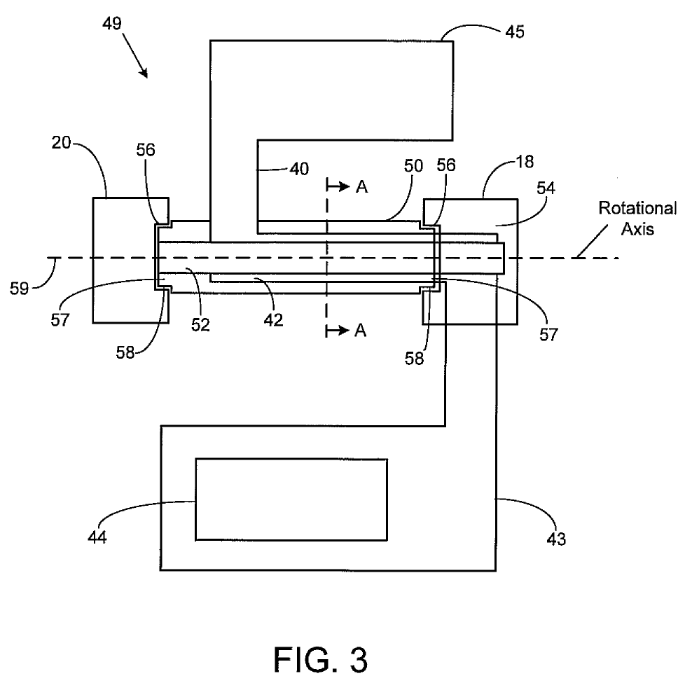

The hinge 16 permits the phone 10 to be opened and closed. The hinge 16 includes to a pair of opposing bosses 18, 20 aligned along a rotational axis of the hinge 59 (see FIGS. 2-3) and a hollow portion 21 having ends respectively engaging the bosses 18, 20. The hollow portion 21 is rotatable about the rotational axis 59, relative to the bosses 18, 20.

The wiring running through the hinge 16 between electronic components in the upper and lower halves 12, 14 may be any suitable conductor, including one or more individual wires, an FPCB having one or more conductive traces, or the like. In the exemplary phone 10 described herein, the wiring is an FPCB.

The bosses 18, 20 may be integrally formed as part of the lower half housing, and the rotatable hollow portion 21 may be integrally formed as part of the upper half housing.

Although FIG. 1 shows a cellular phone 10, the hinge assembly 49 described herein can be used in any electronic device having wiring routed through a hinge that connects hinged components of the device. For example, the hinge 16 may be included in other wireless communication devices, such as headsets, personal digital assistants (PDAs), smart phones, or the like, as well as other electronic devices, such as laptop or portable computers.

FIG. 2 is a plan view of the flexible printed circuit board (FPCB) 40 included in the phone 10 shown in FIG. 1. The FPCB 40 includes an upper portion 45, a lower portion 43, and an insert portion 42 connecting the upper and lower portions, 45, 43. The lower portion 43 includes a header connector 44, and the upper portion 45 includes a second header connector, which is not shown in FIG. 2, as it is located on the opposite side of the upper portion 45, in this example.

The FPCB 40 acts as wiring between the header connectors. The header connectors are electrical connectors that connect, respectively, to electrical components separately located in upper and lower halves 12, 14 of the phone 10. The header connectors can be any suitable type of connector, including those that have a multitude of individual pins (e.g., 40 pins) for making a multitude of individual electrical contacts with the components. The FPBC 40 includes one or more traces for electrically connecting the pins on the different header connectors. The traces are formed along the upper and lower portions 45, 43 and pass between the two portions 45, 43 by way of the insert portion 42. The traces can be metallic layers formed on and/or within the FPCB 40.

The FPCB 40 can have any suitable number of layers for carrying the wiring, for example, six layers.

FIG. 3 is a cross-sectional view of the hinge assembly 49 of the cellular phone 10 show in FIG. 1. The assembly 49 includes the hinge 16 configured to route and conceal electrical wiring (e.g., a portion of FPCB 40). The hinge 16 includes the opposing bosses 18, 20 aligned along the rotational axis 59 and a hollow portion 50 having ends 57 respectively engaging the bosses 18, 20. The hollow portion 50 is rotatable about the rotational axis 59, relative to the bosses 18, 20. The FPCB 40 has the insert portion 42 thereof inserted into the hollow portion 50.

A rod 52 is inserted into the hollow portion 50 and aligned along the rotational axis 59. The rod 52 fixes the inserted portion 42 of the FPCB 40 in a neutral position, avoiding contact with the interior walls of the hinge 16, and thus, reduces wear and tear on the FPCB 40 caused by the hinge action. The rod also keeps the FPCB from stretch and/or skewing inside the hinge. The addition of the rod 52 into the interior of the hinge 16 significantly improves the reliability of the electrical connection passing through the hinge 16.

The hollow portion 50 of the hinge 16 is preferably a cylindrically-shaped tube, but it may be implemented in other shapes. Each end 57 of the hollow portion 50 is necked down to form a reduced annular contact surface 58 for snuggly engaging corresponding annular receptacles 56 formed in each boss 18, 20.

The left boss 18 can include an interior hollow cavity 54 for receiving and concealing a portion the FPCB 40. A slot (not shown) may be formed in the boss 18 so that the FPCB 40 can be slid edgewise into the cavity 54.

The components 18, 20, 50, 52 of the hinge 16 made be made of any suitable material, such as injection molded plastic or the like. Alternatively, the rod 52 made be made of metal. Although shown as a cylinder, the rod 52 may have any other suitable shape.

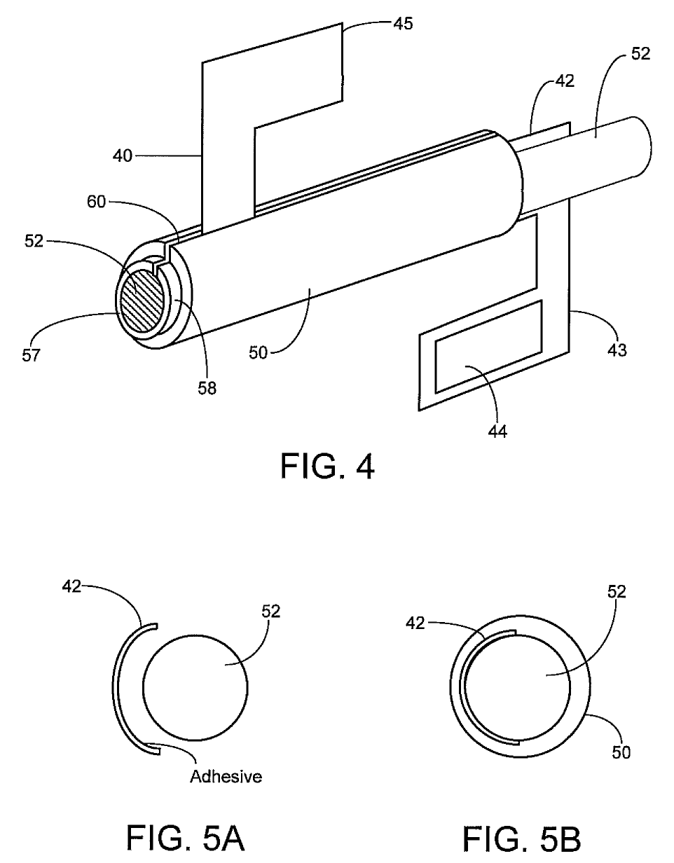

FIG. 4 is a perspective view of the rotatable hollow portion 50 of the hinge assembly 49 with the flexible printed circuit board 40 inserted. The hollow portion 50 includes a slot 60 running lengthwise and formed completely through its wall so that the FPCB 40 can be slid into the hollow portion 50 edgewise at one of the ends 57.

To assemble the hinge assembly 49, the insert portion 42 of the FPCB 40 is first free-formed (i.e., bent) into a shape that contours the exterior surface of the rod 52, as shown in FIG. 5A. FIG. 5A is a cross-sectional view of the insert portion 42 of the FPCB 40 prior to attachment to the rod 52. An adhesive is applied between the FPCB insert portion 42 and rod 52, preferably by applying it to a surface of the FPCB insert portion 42, and then the insert portion 42 is glued to the rod 52, as shown in FIG. 5B. FIG. 5B is a cross-sectional view of the hollow portion 50 of the hinge 16 along section A-A of FIG. 4, with the insert portion 42 attached to the rod 52.

After attaching the FPCB insert portion 42 to the rod 52, the rod 52 and the insert portion 42 are slid into one end 57 of the hollow portion, with the FPCB edge aligned in the slot 60. The rod 52 is then press-fitted into the opening at the other end 57 of the hollow portion 50, at the reduced annular end 58 of the hollow portion 50. The opening may be sized to snuggly engage the rod 52. The assembled hollow portion 50, as shown in FIG. 4, is then snap-fitted into the bosses 18, 20 by first sliding the exposed left part of the FPCB insert portion 42 edgewise into the slot of the left boss 18 so that the exposed left part of the FPCB insert portion 42 is concealed in the interior cavity 54, and then snapping the right end 57 of the hollow portion 50 into the receptacle 56 of right boss 20.

The left boss 18 may include in its interior an annular bearing surface (not shown) centered and orthogonally aligned with the rotational axis 59 for receiving and snuggly engaging the inserted end of the rod 52.

Other embodiments and modifications of this invention will occur readily to those of ordinary skill in the art in view of these teachings. The above description is illustrative and not restrictive. The invention is to be limited only by the following claims, which cover all such other embodiments and modifications, when viewed in conjunction with the above specification and accompanying drawings. The scope of the invention should, therefore, not be limited to the above description, but instead should be determined with reference to the appended claims along with their full scope of equivalents.

What is claimed is:

1. A hinge having a rotational axis, comprising:
a pair of opposing bosses aligned along the rotational axis;
a hollow portion having ends respectively engaging the bosses, the hollow portion rotatable about the rotational axis;
wiring having a portion thereof inserted into the hollow portion; and
a rod inserted into the hollow portion and aligned along the rotational axis.

2. The hinge of claim 1, further comprising:
an adhesive applied to the portion of the wiring inserted into the hollow portion.

3. The hinge of claim 2, wherein the adhesive secures the wiring to the rod.

4. The hinge of claim 1, wherein the portion of the wiring inserted within the hollow portion is shaped to wrap around at least part of the exterior surface of the rod.

5. The hinge of claim 1, included in an electronic device.

6. The hinge of claim 2, included in a wireless communication device.

7. The hinge of claim 1, wherein at least one of the bosses includes an interior cavity and part of the wiring passes through the interior cavity.

8. The hinge of claim 1, wherein the hollow portion includes a longitudinal slot.

9. A wireless communication device having hinged elements, comprising:
a hinge coupling the hinged elements, the hinge including:
a pair of opposing bosses aligned along a rotational axis of the hinge;
a hollow portion having ends respectively engaging the bosses, the hollow portion being rotatable about the rotational axis;
a flexible printed circuit board having a portion thereof inserted into the hollow portion of the hinge; and
a rod inserted into the hollow portion and aligned along the rotational axis.

10. The wireless communication device of claim 9, wherein the opposing bosses are integrally formed into a first housing element of the wireless communication device and the hollow portion is integrally formed into a second housing element of the wireless communication device.

11. The wireless communication device of claim 9, wherein the flexible printed circuit board connects a plurality of electronic components located in a first hinged element and a second hinged element.

12. The wireless communication device of claim 9, further comprising:
an adhesive applied to the portion of the flexible circuit board inserted into the hollow portion.

13. The wireless communication device of claim 12, wherein the adhesive secures the flexible printed circuit board to the rod.

14. The wireless communication device of claim 9, wherein the portion of the flexible printed circuit board inserted within the hollow portion is shaped to wrap around at least part of the exterior surface of the rod.

15. The wireless communication device of claim 9, wherein the rod is cylindrical.

16. A method for routing a flexible printed circuit board through a hinge, comprising:
securing a rod within a rotatable portion of the hinge; and
inserting a portion of the flexible printed circuit board into the rotatable portion of the hinge.

17. The method of claim 16, further comprising:
applying an adhesive on a surface of the flexible printed circuit board; and
securing the rod to the adhesive on the flexible printed circuit board.

18. The method of claim 16, further comprising:
shaping the portion of the flexible printed circuit board to wrap around at least part of the surface of the rod.

19. The method of claim 16, wherein the hinge connects two elements in an electronic device.

20. The method of claim 19, wherein the flexible printed circuit board connects a plurality of components in the two elements.
